(19) United States
(12) Patent Application Publication
(10) Pub. No.: US 2015/0316219 A1
(43) Pub. Date: Nov. 5, 2015

(54) HIGH-PASS FILTER FOR LED LIGHTING

(71) Applicant: CoreLED Systems, LLC, Livonia, MI (US)

(72) Inventors: Derek Mallory, Plymouth, MI (US); John Kahl, Troy, MI (US)

(73) Assignee: CoreLED Systems, LLC, Livonia, MI (US)

(21) Appl. No.: 14/266,871

(22) Filed: May 1, 2014

(51) Int. Cl. F21K 99/00

(52) U.S. Cl. CPC F21K 9/56

(57) ABSTRACT

An optical member that is shaped to collect light from a source, such as an LED, and refract the light to form a desired beam pattern is made of an optically transmissive or transparent polymeric material in which is dispersed an energy converting phosphor that absorbs blue light and emits visible light at a wavelength that is longer than the absorbed blue light.

### CROSS-REFERENCE TO RELATED APPLICATIONS

Not applicable.

### FIELD OF THE DISCLOSURE

This disclosure relates in part to an optical lens member that blocks blue light and passes longer wavelength light.

### BACKGROUND OF THE DISCLOSURE

Traditional systems requiring long pass filtering use a remote mounted filter element following the optical beam-shaping lens. This type of long pass filter is desired in various lighting systems that use a white light emitting LED. White light emitting LEDs use a blue semiconductor die coated with a frequency down converting phosphor of the common YAG or other types, which results in a shift up in the wavelength range of the visible light spectrum. The typical white phosphor converting “PC-LED” has light extending into the mid visible wavelength range and throughout the spectrum into the red region from a narrow emission segment in the blue, lower wavelength region of the spectrum. A common characteristic of a phosphor coated LED die is regions of the die or “chip” that are not completely coated with a sufficient layer of phosphor and a strong blue light emission results at certain angles of light emission from the die, adding to short wavelength light that the long pass filter needs to eliminate.

A negative aspect of the remote long pass filter is a loss of efficiency from high angle light reflection. The filtering medium may be of one of two types or a combination of both. The first being a wavelength absorbing dye and the second a frequency down converting phosphor (wavelength lengthening). The dye attenuates wavelength below the desired long pass wavelength. The dye filtering often does not have a sharp cut off and absorbs some wavelength in the desired long pass region causing a reduction in efficiency. The phosphor converting compounds absorb shorter wavelength blue light and re-emit light energy at a longer wavelength.

### SUMMARY OF THE DISCLOSURE

The optical lens disclosed herein may advantageously employ a light-filtering compound and/or a phosphor that is uniformly dispersed throughout an optically transmissive polymeric material of which the optical lens is comprised.

In certain aspects of this disclosure, a compound capable of both filtering blue light (i.e., visible light at a wavelength below 500 nm) and converting blue light to visible light at wavelength above 500 nm can be dispersed throughout an optically transmissive polymeric material that is shaped into an optical lens that is capable of shaping light from a source into a desired beam.

In certain aspects of this disclosure, a moldable composition including an optically transmissive polymeric material and an energy converting phosphor dispersed in the polymeric material is provided, wherein the phosphor is characterized by an ability to absorb blue light and emit visible light at a wavelength that is longer than that of the blue light.

In certain aspects of this disclosure, the lens or other item molded from the moldable composition allows at least 85% of the visible light having a wavelength greater than 500 nm to be transmitted.

In certain aspects of this disclosure, the lens or other item molded from the moldable composition allows at least 80% of the visible light energy having a wavelength from 360 nm to 500 nm to be absorbed by the phosphor and re-emitted as visible light having a wavelength greater than 500 nm.

In certain aspects of this disclosure, the phosphor is perylene.

In various aspects, a lens that collects light from a source and shapes the light into a desired beam pattern also acts as a filtering and/or wavelength shifting element to reduce the intensity of visible light at a wavelength below 500 nm and, in some embodiments using phosphors, increase the intensity of visible light at a wavelength above 500 nm.

### BRIEF DESCRIPTION OF THE DRAWING

FIG. 1 is a perspective view of an optical member shaped to collect light from a source and refract the light into a desired beam pattern.

### DETAILED DESCRIPTION

The optically transmissive polymeric materials disclosed herein can be shaped into lens members that focus or disperse light, shaped for use as a color (wavelength) filtering element, or used as a coating or encapsulant on a light source (e.g., an LED). The optically transmissive polymeric materials disclosed herein can also be used in the fabrications of reflective elements. For example, a color-filtering reflector can be made by molding an appropriately shaped component and applying a reflective metalized film layer to a facet of the component.

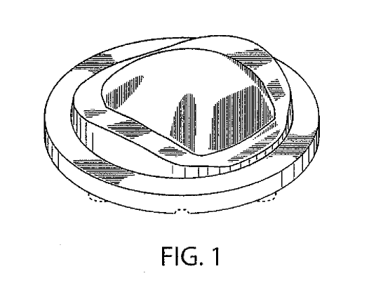

Shown in FIG. 1 is an example of an optical member 10 in accordance with this disclosure. The optical member 10 can, for example, be mounted over an LED (not shown) attached to a circuit board (not shown).

The optically transmissive polymeric material is any moldable thermoplastic or thermosettable material into which a dye and/or phosphor can be dispersed, and which can subsequently be shaped and solidified to form a solid lens or other object capable of transmitting visible light. Suitable optically transmissive polymeric materials include highly transmissive materials such as acrylic polymers (e.g., polymethylmethacrylate), butyrates (e.g., cellulose acetate butyrate), polycarbonates (e.g., those sold under the “Lexan” brand), transparent silicones, and glycol modified polyethylene terephthalate.

The phosphor is a compound that is capable of absorbing visible light in the blue region from about 380 nm to about 490 nm (or wavelengths less than 500 nm) and re-emit visible light at longer wavelengths greater than 500 nm. The phosphor is preferably a compound that can be uniformly dispersed in the optically transmissive polymeric material and which is stable in admixture with the optically transmissive polymeric material. Desirably, the phosphor is selected from compounds and can achieve the desired absorption of blue light (about 380 nm to about 490 nm wavelengths) and re-emission of longer wavelength light in a highly efficient manner (i.e., nearly complete conversion of the light with very little or no heat generation) and without significantly interfering with the optical transmissivity of the composite material (i.e., the polymeric material, the phosphor and any other additions, such as stabilizers). An example of a suitable phosphor that can be employed in the lenses and moldable composition of this disclosure is perylene. An effective amount of perylene in the moldable composition that may be used to make a lens in accordance with this disclosure is from about 0.005 parts by weight per 100 parts by weight of the optically transmissive polymeric material to about 0.2 parts by weight per 100 parts by weight (pph) of the optically transmissive polymeric material, 0.01 to 0.1 pph, or 0.02 to 0.1 pph. Higher or lower amounts of perylene can be used, although excessive amounts can have an adverse effect on transmissivity, cost and/or processability, and very low amounts may not be sufficiently effective.

The lenses and other articles prepared from the moldable composition of this disclosure can achieve at least 70%, 80% or 85% transmission of visible light having a wavelength greater than 500 nm, and at least 60%, 70% or 80% conversion of light energy having a wavelength from 360 nm to 500 nm to visible light having a wavelength greater than 500 nm.

The term “blue light” refers to the short wavelength blue region of photopic light in the 380 nm to 490 nm range. The phosphor conversion re-emission in the lens can boost the overall photopic efficiency moving the short wavelength blue light toward the center of the photopic range, which peaks at 555 nm. A benefit of a phosphor lens long pass filter is the emission light will typically fall above 500 nm and mix with the original LED phosphor emission spectrum for additional spectrum fill that boost the CRI (Color Rendering Index) improving the quality of light void of the short wavelength blue spectrum. In a long pass filtering lens with both an absorbing dye and a phosphor converter, some of the attenuation of the desired long wavelength light by the absorbing dye can be overcome by the re-emission of the phosphor into the desired range about 500 nm.

The lens and other articles prepared from the moldable compositions of this disclosure can be molded or otherwise shaped to refract light, such as into converging or diverging beams (i.e., shape the light into a desired beam pattern).

In certain aspects of this disclosure, a leans is fabricated (e.g., molded) from a composition comprising an optically transmissive polymeric material (e.g., polymethylmethacrylate) and a non-phosphor dye that selectively blocks visible light at a wavelength below 500 nm. Such dyes or tints include various green and/or amber dyes that are used in automotive applications, such as in SAE 937 amber resin and green resin.

Table 1 shows total light transmission for lenses made of SAE Amber 937 resin and Green resin, which are used with Nichia low Kelvin Warm White LEDs having Correlated Color Temperatures (CCTs) of 2800 K and 2400K. The results in Table 1 show that most of the light energy (Lumen) is transmitted for the SAE Amber 937 for both LEDs (54% and 77%, respectively). For the Green resin, substantially all of the light energy is transferred or re-emitted at wavelengths above 500 nm. With both the SAE Amber 937 and Green resin lenses, substantially all light energy at a wavelength below 500 nm is eliminated. In all cases, the CCT is shifted downwardly toward warmer colors. Color Rendering Index (CRI) is good in all cases, particularly for the lenses fabricated from the Green resin.

TABLE 1
SUMMARY OF DATA

| | | Lumen/light | Energy | | | |
|---|---|---|---|---|---|---|
| | LED (1) | transmission | below 500 | CCT- | | |
| Filter | Ref. CCT | (1) | nm (1) | Kelvin | CRI | Note |
| SAE Amber 937 | 2,800K | 59% | 0.46% | 1,747 | 40.7 | Absorption Filter |
| Green | 2,800K | 104% | 1.5% | 2,616 | 70.5 | Fluorescence |
| | | | | | | Filter |
| | LED (2) | Lumen/light | Energy | | | |
| | Ref. CCT | transmission | below 500 | CCT- | | |
| Filter | (Nichia) | (2) | nm (2) | Kelvin | CRI | Note |
| SAE Amber 937 | 2,400K | 77% | 0.27% | 1,511 | 41.3 | Absorption Filter |
| Green | 2,400K | 104% | 0.50% | 2,124 | 68.2 | Fluorescence |
| | | | | | | Filter |

Notes:
(1) SAE 937 amber = standard off the shelf resin
(2) Green = custom compounded resin

What is claimed is:

1. An optical member shaped to collect light from a source and refract the light to form a desired beam pattern, comprising:
an optically transmissive polymeric material; and
an energy converting phosphor dispersed in the optically transmissive polymeric material, the energy converting phosphor being characterized by an ability to absorb blue light and emit visible light at a wavelength that is longer than that of the blue light.

2. The optical member of claim 1, in which at least 85% of visible light having a wavelength greater than 500 nm is transmitted through the lens.

3. The optical member of claim 1, in which at least 80% of visible energy light having a wavelength from 360 nm to 500 nm entering the lens is absorbed and re-emitted as visible light having a wavelength greater than 500 nm.

4. The optical member of claim 1, in which the optically transmissive polymeric material comprises an acrylic polymer.

5. The optical member of claim 1, in which the optically transmissive polymeric material comprises polymethylmethacrylate.

6. The optical member of claim 1, in which the optically transmissive polymeric material comprises a material selected from the group consisting of cellulose acetate butyrate, polycarbonate and glycol modified polyethylene terephthalate.

7. The optical member of claim 1, in which the phosphor is perylene.

8. The optical member of claim 7, in which the perylene is present in the lens in an amount of from about 0.005 parts by weight per 100 parts by weight of the optically transmissive material to about 0.2 parts by weight per 100 parts by weight of the optically transmissive material.

9. A moldable composition comprising:
an optically transmissive polymeric material; and
an energy converting phosphor dispersed in the optically transmissive polymeric material, the energy converting phosphor being characterized by an ability to absorb blue light and emit visible light at a wavelength that is longer than that of the blue light.

10. The composition of claim 9, in which the optically transmissive polymeric material comprises an acrylic polymer.

11. The composition of claim 9, in which the optically transmissive polymeric material comprises polymethylmethacrylate.

12. The composition of claim 9, in which the optically transmissive polymeric material comprises a material selected from the group consisting of cellulose acetate butyrate, polycarbonate and glycol modified polyethylene terephthalate.

13. The composition of claim 9, in which the phosphor is perylene.

14. The composition of claim 9, in which the perylene is present in the lens in an amount of from about 0.005 parts by weight per 100 parts by weight of the optically transmissive material to about 0.2 parts by weight per 100 parts by weight of the optically transmissive material.

15. An optical lens shaped to collect light from a source and refract the light to form a desired beam pattern, comprising:
an optically transmissive polymeric material; and
a light-filtering compound that preferentially absorbs visible light at wavelengths less than 500 nm and which is present in an amount effective to selectively absorb most visible light at wavelengths below 500 nm and transmit most visible light at wavelengths above 500 nm.

16. The lens of claim 15, in which the optically transmissive polymeric material comprises an acrylic polymer.

17. The lens of claim 15, in which the optically transmissive polymeric material comprises polymethylmethacrylate.

18. The lens of claim 15, in which the optically transmissive polymeric material comprises a material selected from the group consisting of cellulose acetate butyrate, polycarbonate and glycol modified polyethylene terephthalate.

19. The lens of claim 15, in which the light filtering compound is an amber dye.
